(19) United States
(12) Patent Application Publication
(10) Pub. No.: US 2025/0029625 A1
(43) Pub. Date: Jan. 23, 2025

(54) SIGNAL PROCESSING DEVICE, SIGNAL PROCESSING METHOD, AND SIGNAL PROCESSING PROGRAM

(71) Applicant: NIPPON TELEGRAPH AND TELEPHONE CORPORATION, Tokyo (JP)

(72) Inventors: Tsubasa OCHIAI, Tokyo (JP); Marc DELCROIX, Tokyo (JP); Rintaro IKESHITA, Tokyo (JP); Hiroshi SATO, Tokyo (JP); Shoko ARAKI, Tokyo (JP)

(73) Assignee: NIPPON TELEGRAPH AND TELEPHONE CORPORATION, Tokyo (JP)

(21) Appl. No.: 18/715,189

(22) PCT Filed: Dec. 3, 2021
(86) PCT No.: PCT/JP2021/044564

§ 371 Date: May 31, 2024

(51) Int. Cl. G10L 21/0224; G10L 15/26; G10L 21/0216

(52) U.S. Cl. CPC G10L 21/0224; G10L 15/26; G10L 2021/02163

(57) ABSTRACT

A signal processing device (10) includes: a speech enhancement unit (11) that generates, from an observation signal, an enhancement signal in which a voice of a speaker is enhanced; an original sound addition unit (12) that adds the observation signal to the enhancement signal; and a speech recognition unit (13) that performs speech recognition on the enhancement signal to which the observation signal is added by the original sound addition unit (12).

### TECHNICAL FIELD

The present invention relates to a signal processing device, a signal processing method, and a signal processing program.

### BACKGROUND ART

It is a challenge in speech processing to construct a speech recognition system that is robust against acoustic interference such as background noise and reverberation. Here, it has been confirmed that a multi-channel speech enhancement technology (beamformer) using a plurality of microphones greatly improves speech recognition performance.

### CITATION LIST

### Non Patent Literature

Non Patent Literature 1: Szu-Jui Chen, Aswin Shanmugam Subramanian, Hainan Xu, and Shinji Watanabe, “Building state-of-the-art distant speech recognition using the chime-4 challenge with a setup of speech enhancement baseline”, in Interspeech, 2018, pp. 1571-1575.

### SUMMARY OF INVENTION

### Technical Problem

On the other hand, in the single channel speech enhancement technology using a single microphone, even if an enhancement signal from which noise is removed is used, the speech recognition performance may be lower than an observation signal with noise, and the effect on improving the speech recognition performance is limited.

In practice, many devices are provided with only one microphone. Accordingly, in order to implement a robust speech recognition system, it is important to develop a speech enhancement technology for a single channel as well as a multi-channel speech enhancement technology.

The present invention has been made in view of the above, and an object thereof is to provide a signal processing device, a signal processing method, and a signal processing program capable of improving speech recognition performance by speech enhancement.

### Solution to Problem

In order to solve the above-described problems and achieve the object, a signal processing device according to the present invention includes: a speech enhancement unit that generates, from an observation signal, an enhancement signal in which a voice of a speaker is enhanced; an addition unit that adds the observation signal to the enhancement signal; and a speech recognition unit that performs speech recognition on the enhancement signal to which the observation signal is added by the addition unit.

### Advantageous Effects of Invention

According to the present invention, it is possible to improve speech recognition performance by speech enhancement.

### BRIEF DESCRIPTION OF DRAWINGS

FIG. 1 is a diagram illustrating signal decomposition of an enhancement signal by orthogonal projection.

FIG. 2 is a diagram illustrating a word error rate (WER) for an evaluation enhancement signal.

FIG. 3 is a diagram illustrating signal decomposition of a modified enhancement signal obtained by adding an observation signal to an enhancement signal.

FIG. 4 is a diagram schematically illustrating an example of a configuration of a signal processing device according to an embodiment.

FIG. 5 is a flowchart illustrating the processing procedure of a signal processing method according to the embodiment.

FIG. 6 is a diagram illustrating SDR, SNR, and SAR for a modified enhancement signal.

FIG. 7 is a diagram illustrating a WER score for a modified enhancement signal.

FIG. 8 is a diagram illustrating a WER score by the signal processing device for an observation signal by actual recording.

FIG. 9 is a diagram illustrating an example of a computer in which a program is executed to implement the signal processing device.

### DESCRIPTION OF EMBODIMENTS

Hereinafter, an embodiment of the present invention will be described in detail with reference to the drawings. Note that the present invention is not limited by this embodiment. Furthermore, in the description of the drawings, the same parts are denoted by the same reference numerals. Note that in the following description, when “\hat{ }A” is used to describe A that is a vector or a matrix, it is assumed that the expression is equivalent to “the symbol in which “\hat{ }” is provided immediately above “A””. When “ A” is used to describe A that is a vector or a matrix, it is assumed that the expression is equivalent to “the symbol in which “ ” is provided immediately above “A””.

### Embodiment

The present embodiment proposes, as an example, a signal processing method for improving speech recognition performance on the basis of an analysis result obtained by analyzing a factor that degrades speech recognition performance of an enhancement signal of single channel speech enhancement (SE). Note that in the present embodiment, a signal processing method for an audio signal (observation signal) recorded by a single microphone (single channel) will be described, but the present invention is not limited to the single channel, and can be applied to audio signals recorded by a plurality of microphones (multi-channel).

### Analysis of Enhancement Signal

First, a factor that degrades speech recognition performance of an enhancement signal of single channel SE was analyzed.

Usually, it is often assumed that processing distortion caused by the single channel SE is a cause of deterioration in speech recognition performance. However, such distortion, particularly the influence on speech recognition, has not been systematically analyzed in detail or solved. It is considered to be essential to elucidate the influence of the single channel SE estimation error on speech recognition in order to improve SE front-end design.

Here, a single channel SE task is focused. y∈R^{T} indicates a T long-time domain waveform of an observation signal. The observation signal y is modeled as Expression (1). s∈R^{T} represents a sound source signal. n∈R^{T} indicates a background noise signal.

$$\begin{matrix}[ Math . 1 ] & \\ y = s + n & ( 1 )\end{matrix}$$

SE aims to reduce the noise signal n from the observation signal y. When the observation signal y is input, an enhancement signal \hat{ }s∈R^{T} is estimated as \hat{ }s=SE(y). SE(·) indicates SE processing performed by a neural network, for example.

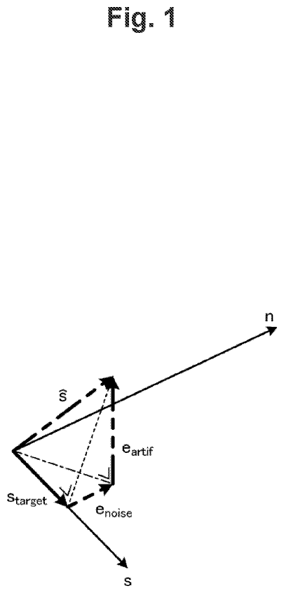

Subsequently, in order to analyze the influence of an SE estimation error on speech recognition performance, SE estimation error decomposition was examined using orthogonal projection. FIG. 1 is a diagram illustrating signal decomposition of an enhancement signal by orthogonal projection.

Since the enhancement signal \hat{ }s is acquired by performing estimation processing, it is inevitable that the enhancement signal \hat{ }s includes an estimation error. The enhancement signal \hat{ }s is decomposed using orthogonal projection as in Expression (2).

$$\begin{matrix}[ Math . 2 ] & \\ \hat{s} = {s}_{target} + {e}_{noise} + {e}_{artif} & ( 2 )\end{matrix}$$

In Expression (2), s_{target} indicates a target sound source element, eₙₒᵢₛₑ ∈R^{T} indicates a noise element (error), and e_{artif} ∈R^{T} indicates an artifact element (error) (see FIG. 1).

Specifically, error decomposition by orthogonal projection decomposes an error in SE into a noise element and an artifact element. These two elements are obtained by projecting the SE error in an audio/noise subspace across an audio/noise signal and in a subspace orthogonal to the audio/noise subspace.

Since the noise element eₙₒᵢₛₑ includes a linear combination of an audio signal and a noise signal, it is expected that the noise element eₙₒᵢₛₑ is a signal that can be observed naturally. These are called natural signals. Since similar noise elements naturally appear in training samples, the influence of the natural signal on speech recognition performance may be limited.

On the other hand, the artifact element e_{artif} includes a signal that cannot be represented by a linear combination of an audio signal and a noise signal (see FIG. 1), and is an artificial/unnatural signal. This unnatural signal can be very diverse and may be hardly visible in a training sample. Accordingly, it is assumed that speech recognition is more sensitive to artifact elements than noise elements.

As an SE evaluation index, a signal to distortion ratio (SDR) (Expression (3)), a signal to noise ratio (SNR) (Expression (4)), and a signal to artifact ratio (SAR) (Expression (5)) are used.

$$\begin{matrix}[ Math . 3 ] & \\ SDR := 10 {log}_{10} \frac{{‖ {s}_{t a r g e t} ‖}^{2}}{{‖ {e}_{n o i s e} + {e}_{a r t i f} ‖}^{2}} & ( 3 )\end{matrix}$$

$$\begin{matrix}[ Math . 4 ] & \\ SNR := 10 {log}_{10} \frac{{‖ {s}_{t a r g e t} ‖}^{2}}{{‖ {e}_{n o i s e} ‖}^{2}} & ( 4 )\end{matrix}$$

$$\begin{matrix}[ Math . 5 ] & \\ SAR := 10 {log}_{10} \frac{{‖ {s}_{t a r g e t} + {e}_{n o i s e} ‖}^{2}}{{‖ {e}_{a r t i f} ‖}^{2}} & ( 5 )\end{matrix}$$

Next, an experiment was conducted to examine the influence of the error element on the speech recognition performance of the artifact element e_{artif}. In the experiment, in order to measure the influence of the artifact element e_{artif} and the noise element eₙₒᵢₛₑ on the speech recognition performance, the enhancement signal was modified by changing the magnitude of the error element, and speech recognition was performed using the modified enhancement signal as an input.

Specifically, after decomposing the enhancement signal \hat{ }s using orthogonal projection, an enhancement signal \hat{ }s_{ω}∈R^{T} was synthesized by increasing or decreasing the artifact element e_{artif} and the noise element eₙₒᵢₛₑ as in Expression (6).

$$\begin{matrix}[ Math . 6 ] & \\ \begin{matrix}{\hat{s}}_{ω} = {s}_{target} + {ω}_{n o i s e} & {e}_{noise} & + {ω}_{artif} {e}_{artif}\end{matrix} & ( 6 )\end{matrix}$$

Here, ωₙₒᵢₛₑ is a parameter that controls the quantity of the noise element eₙₒᵢₛₑ, and ω_{artif} is a parameter that controls the quantity of artifact element e_{artif}. In this experiment, in order to obtain various enhancement signals \hat{ }s_{ω}having different ratios of noise elements and artifact elements, values of ωₙₒᵢₛₑ and ω_{artif} are changed. As a result, it is possible to hold the same target sound source element s_{target} while controlling the values of SNR and SAR. By inputting such a modified enhancement signal to the speech recognition system as an evaluation enhancement signal, the influence of each error element on the speech recognition performance was directly measured.

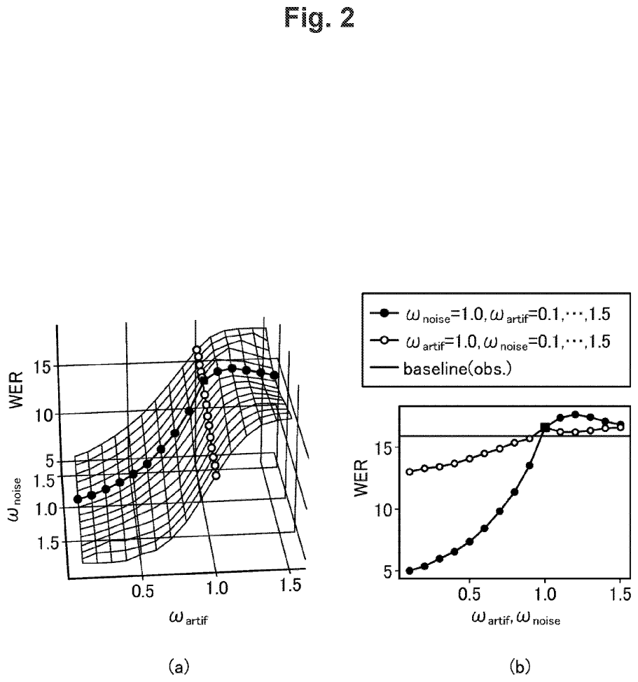

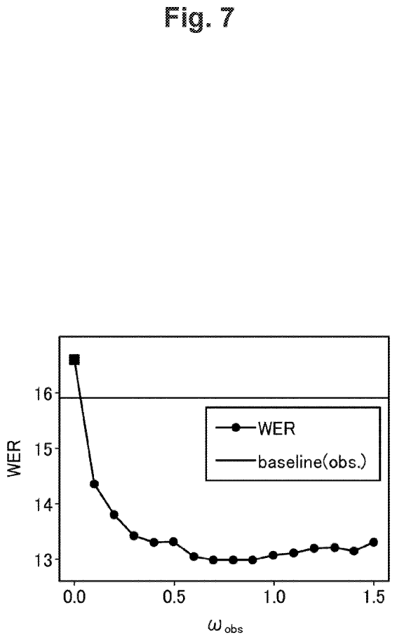

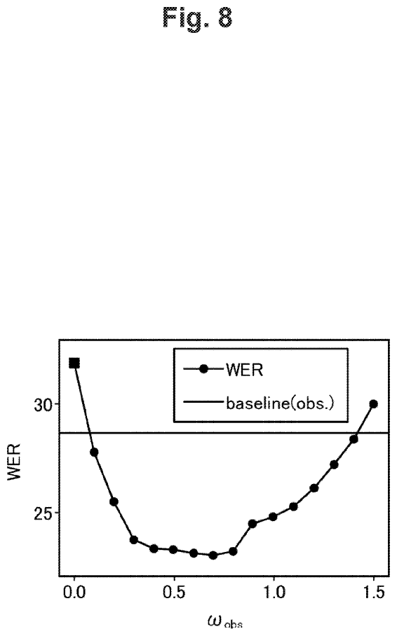

FIG. 2 is a diagram illustrating WER for an evaluation enhancement signal. Here, (a) of FIG. 2 is a 3D plot illustrating the speech recognition result for the evaluation enhancement signal in which the ratio of the noise/artifact error is modified. Meanwhile, (b) of FIG. 2 is a corresponding 2D plot obtained by modifying only one of the weights of ωₙₒᵢₛₑ and ω_{artif}. The baseline (obs.) in (b) of FIG. 2 represents a reference WER score of the observation signal, and the square symbol represents a WER score of the original enhancement signal without modification. The same applies to the baseline (obs.) and the square symbols in FIGS. 7 and 8.

As illustrated in FIG. 2, it can be confirmed that the original enhancement signal actually lowers the speech recognition performance as compared with the observation signal. As illustrated in FIG. 2, it was observed that by reducing the artifact element e_{artif}, speech recognition performance can be significantly improved. On the other hand, the speech recognition performance was not so affected even if the noise element eₙₒᵢₛₑ was increased or decreased. From these results, it has been confirmed that, of the noise element eₙₒᵢₛₑ and the artifact element e_{artif}, the artifact element e_{artif} has a larger influence on the degradation of the speech recognition performance.

Therefore, based on this finding, the present embodiment proposes a signal processing method for improving speech recognition performance. In the present embodiment, as an approach for reducing the influence of the artifact element, a method for reducing the ratio of the artifact component in a signal input to the speech recognition system has been studied.

In the present embodiment, the original sound (observation signal) is added to the enhancement signal to reduce the ratio of the artifact element in the signal input to the speech recognition system. Specifically, a signal obtained by adding the scaled observation signal y to the enhancement signal \hat{ }s is input to the speech recognition system as a modified enhancement signal s. The modified enhancement signal s∈R^{T} is calculated as in Expression (7).

$$\begin{matrix}[ Math . 7 ] & \\ \overline{s} = \hat{s} + {ω}_{o b s} y & ( 7 )\end{matrix}$$

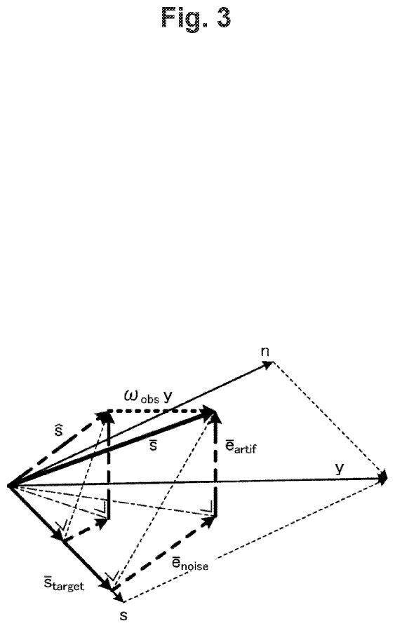

ω_{obs}≥0 is a parameter for controlling the quantity of the observation signal y added to the enhancement signal \hat{ }s. FIG. 3 is a diagram illustrating signal decomposition of a modified enhancement signal obtained by adding an observation signal to an enhancement signal. As illustrated in FIGS. 1 and 3, the artifact element e_{artif} corresponds to a perpendicular of the enhancement signal \hat{ }s with respect to an Sn plane. Even in a case where the observation signal y is added to the enhancement signal \hat{ }s, since the observation signal y is parallel to the Sn plane, the length of the vector of the artifact element e_{artif} does not change between the modified enhancement signal s and the enhancement signal \hat{ }s.

On the other hand, since the observation signal y is added to the enhancement signal \hat{ }s in the modified enhancement signal s, a target sound source element s_{target} and a noise element eₙₒᵢₛₑ are increased as compared with the enhancement signal \hat{ }s. Accordingly, the modified enhancement signal s can reduce the ratio of the artifact element e_{artif} as compared with the enhancement signal \hat{ }s. Therefore, the influence of the artifact element e_{artif} on the speech recognition can be reduced by using the modified enhancement signal s, so that improvement in the speech recognition performance can be expected. As described below, it can also be mathematically proved that the addition of the original sound contributes to the improvement in the speech recognition performance.

A SAR improvement value SARi is calculated as in Equation (8). If SARi>0, the ratio of the artifact element e_{artif} decreases when the original sound addition is performed. Note that Ps∈R^{T×T} indicates an orthogonal projection matrix on the subspace across a sound source signal {s^{T}}_{L-1T=0} (L-1 is number of allowable maximum delays). P_{s,n}∈R^{T×T} indicates an orthogonal projection matrix on the subspace across the sound source signal and a noise signal {s^{T}, n^{T}}_{L-1T=0}.

$$\begin{matrix}[ Math . 8 ] & \\ \begin{matrix}SARi = 10 {log}_{10} \frac{{‖ {P}_{s , n} \overline{s} ‖}^{2}}{{‖ {\overline{e}}_{a r t i f} ‖}^{2}} - 10 {log}_{10} \frac{{‖ {P}_{s , n} \hat{s} ‖}^{2}}{{‖ {\hat{e}}_{artif} ‖}^{2}} \\ = 10 {log}_{10} \frac{{‖ {P}_{s , n} \hat{s} + {ω}_{o b s} y ‖}^{2}}{{‖ {P}_{s , n} \hat{s} ‖}^{2}} \\ = 10 {log}_{10} [ 1 + \frac{{ω}_{o b s}^{2} {‖ y ‖}^{2} + 2 {ω}_{o b s} 〈 {P}_{s , n} \hat{s} , y 〉}{{‖ {P}_{s , n} \hat{s} ‖}^{2}} ]\end{matrix} & ( 8 )\end{matrix}$$

In the equation in the second column in Equation (8), P_{s,n}y=y and e_{artif}=\hat{ }e_{artif} are used. As illustrated in the third column of Expression (8), when <P_{s,n}s, y>>0, SARi>0. Therefore, in order to improve the SAR of the original enhancement signal \hat{ }s=SE(y), <P_{s,n}s, y>>0 is a sufficient condition. This sufficient condition can also be rewritten as Equation (9), and under this loose condition, it can be proved that the ratio of the artifact component in the modified enhancement signal s is reduced by the addition of the original sound.

$$\begin{matrix}[ Math . 9 ] & \\ 〈 {P}_{s , n} \hat{s} , y 〉 = 〈 \hat{s} , {P}_{s , n} y 〉 = 〈 \hat{s} , y 〉 > 0 & ( 9 )\end{matrix}$$

### Signal Processing Device

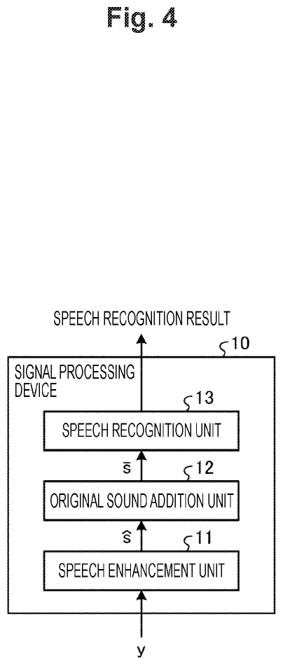

A signal processing device to which original sound addition is applied for improving speech recognition performance will be described. FIG. 4 is a diagram schematically illustrating an example of a configuration of the signal processing device according to the embodiment.

A signal processing device 10 according to the embodiment is implemented by, for example, a predetermined program being read by a computer or the like including a read only memory (ROM), a random access memory (RAM), a central processing unit (CPU), and the like, and the CPU executing the predetermined program. Furthermore, the signal processing device 10 includes a communication interface that transmits and receives various types of information to and from another device connected via a network or the like. As illustrated in FIG. 4, the signal processing device 10 includes a speech enhancement unit 11, an original sound addition unit 12 (addition unit), and a speech recognition unit 13. The observation signal y recorded in a single channel is input to the signal processing device 10, and, for example, a sound recognition result obtained by converting a sound signal into a text is output.

The speech enhancement unit 11 receives input of the observation signal y recorded in a single channel. For the purpose of reducing the noise signal n from the observation signal y, the speech enhancement unit 11 generates the enhancement signal \hat{ }s in which the voice of the speaker is enhanced from the observation signal y. The speech enhancement unit 11 performs speech enhancement processing using, for example, a neural network.

The original sound addition unit 12 adds the observation signal y (original sound) to the enhancement signal \hat{ }s. The original sound addition unit 12 inputs a signal obtained by adding the weighted observation signal y to the enhancement signal \hat{ }s to the speech recognition unit 13 as the modified enhancement signal s (see Expression (7)).

Note that the original sound addition unit 12 adjusts a weight ω_{obs} of the observation signal y to be added to the enhancement signal \hat{ }s according to the ratio of the noise signal included in the observation signal y. For example, in a case where the ratio of the noise signal included in the observation signal y is lower than a certain value, the original sound addition unit 12 may set the value of the weight ω_{obs} lower than the prescribed value. Furthermore, in a case where the ratio of the noise signal included in the observation signal y is higher than the certain value, the original sound addition unit 12 may set the value of the weight ω_{obs} higher than the prescribed value. The original sound addition unit 12 may estimate the SNR of the observation signal y and determine the value of the weight ω_{obs} on the basis of the estimation result.

Furthermore, the original sound addition unit 12 may weight both the observation signal y and the observation signal added to the enhancement signal \hat{ }s in a relationship in which the sum of the weight of the observation signal y and the weight of the observation signal added to the enhancement signal \hat{ }s is 1 as shown in Expression (10).

$$\begin{matrix}[ Math . 10 ] & \\ \overline{s} = ( 1 - {ω}_{o b s} ) \hat{s} + {ω}_{o b s} y & ( 10 )\end{matrix}$$

Furthermore, the original sound addition unit 12 may appropriately set a weight α of the observation signal y and a weight β of the observation signal to be added to the enhancement signal \hat{ }s as shown in Expression (11).

$$\begin{matrix}[ Math . 11 ] & \\ \overline{s} = α \hat{s} + β y & ( 11 )\end{matrix}$$

The speech recognition unit 13 performs speech recognition on the modified enhancement signal s. The speech recognition unit 13 outputs, for example, a speech recognition result obtained by converting the sound signal into a text. The speech recognition unit 13 performs speech enhancement processing using, for example, a learned deep learning model.

### Signal Processing Method

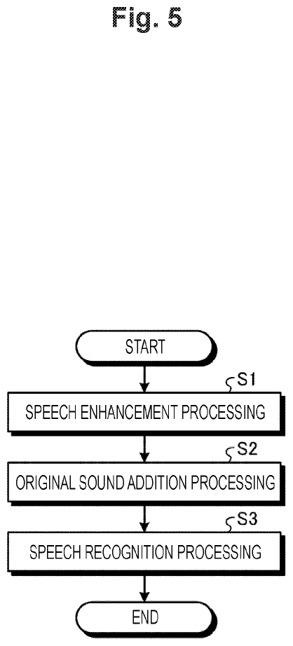

Next, a signal processing method executed by the signal processing device 10 will be described. FIG. 5 is a flowchart illustrating the processing procedure of the signal processing method according to the embodiment.

As illustrated in FIG. 5, in the signal processing device 10, when the input of the observation signal y is received, the speech enhancement unit 11 performs speech enhancement processing of generating the enhancement signal \hat{ }s in which the speech of the speaker is enhanced on the basis of the observation signal y (step S1). The original sound addition unit 12 performs original sound addition processing of adding the observation signal y to the enhancement signal \hat{ }s (step S2). The original sound addition unit 12 inputs a signal obtained by adding the observation signal y to the enhancement signal \hat{ }s to the speech recognition unit 13 as the modified enhancement signal s. The speech recognition unit 13 performs speech recognition processing on the modified enhancement signal s (step S3) and outputs a speech recognition result.

### Evaluation Experiment

In practice, the speech recognition accuracy of the signal processing device 10 was evaluated. A neural network based time-domain denoising network (Denoising-TasNet) was adopted as the speech enhancement unit 11. A deep neural network hidden Markov model (DNN-HMM) hybrid automatic speech recognition (ASR) system based on the standard method of Kaldi was adopted as the speech recognition unit 13. A data set of reproduced reverberant noisy audio signals was generated from the Wall Street Journal (WSJ0) corpus of audio sources and the CHiME-3 corpus of noise sources, and was used as a training set, a development set, and an evaluation set.

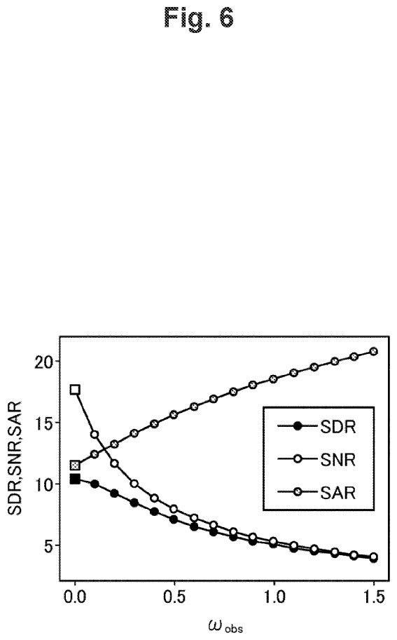

FIG. 6 is a diagram illustrating SDR, SNR, and SAR for the modified enhancement signal s. FIG. 7 is a diagram illustrating scores of WER for the modified enhancement signal s. FIGS. 6 and 7 show results obtained by varying the value of ω_{obs} in Expression (7) between 0.0 and 1.5.

As illustrated in FIG. 6, as ω_{obs} increases, that is, each time an observation signal is added, the SDR and the SNR decrease, while the SAR monotonically increases. In other words, as ω_{obs} increases, an improvement in SAR is observed and the ratio of the artifact element to the modified enhancement signal s decreases. Along with this SAR improvement, an improvement in WER was observed as illustrated in FIG. 7.

Accordingly, the signal processing device 10 was able to improve the performance of speech recognition as compared with the reference observation signal and the original enhancement signal \hat{ }s by performing the original sound addition. In other words, the signal processing device 10 was able to improve the single channel SE front-end speech recognition performance by reducing the ratio of the artifact element in the modified enhancement signal s, that is, by increasing SAR.

Subsequently, the actual recording was evaluated. Actual recorded audio data (et05_real) of the CHiME-3 dataset was used to confirm the results of the actual recording. FIG. 8 is a diagram illustrating a WER score by the signal processing device 10 for an observation signal by actual recording.

As illustrated in FIG. 8, according to the signal processing device 10, it has been observed that the WER is lowered even in the case of application to actual recording. That is, it has been proved that the effect of improving the speech recognition performance by reducing the artifact element is also applied to actual recording.

### Effect of Embodiment

As described above, the signal processing device 10 according to the embodiment adds the observation signal y to the enhancement signal \hat{ }s and inputs the observation signal y to the speech recognition unit 13 in order to reduce the influence of the artifact element on the speech recognition performance. As a result, it has been demonstrated that the signal processing device 10 can monotonously increase the SAR value and improve the speech recognition performance. Furthermore, it has been found that the signal processing device 10 effectively improves the speech recognition performance even in actual recording.

Conventionally, it has been difficult to improve speech recognition performance particularly in single channel speech enhancement. Furthermore, there has been no configuration in which original sound addition is performed as a front end of speech recognition.

The signal processing device 10 according to the present embodiment has succeeded in improving the speech recognition performance in single channel speech enhancement only by adding simple processing of adding the original sound (observation signal) to the enhancement signal to the preceding stage of the speech recognition.

### System Configuration of Embodiment

Each component of the signal processing device 10 is functionally conceptual, and does not necessarily have to be physically configured as illustrated. That is, specific forms of distribution and integration of the functions of the signal processing device 10 are not limited to the illustrated forms, and all or some of them can be functionally or physically distributed or integrated in any unit according to various loads, usage conditions, and the like.

Furthermore, all or any part of the processing performed in the signal processing device 10 may be implemented by a CPU, a graphics processing unit (GPU), and a program analyzed and executed by the CPU and the GPU. Furthermore, the processing performed in the signal processing device 10 may be implemented as hardware by wired logic.

Furthermore, among the processing described in the embodiment, all or part of the processing described as being automatically performed can be performed manually. Alternatively, all or part of the processing described as being manually performed can be automatically performed by a known method. In addition, the above-described and illustrated processing procedures, control procedures, specific names, and information including various data and parameters can be appropriately changed unless otherwise specified.

### Program

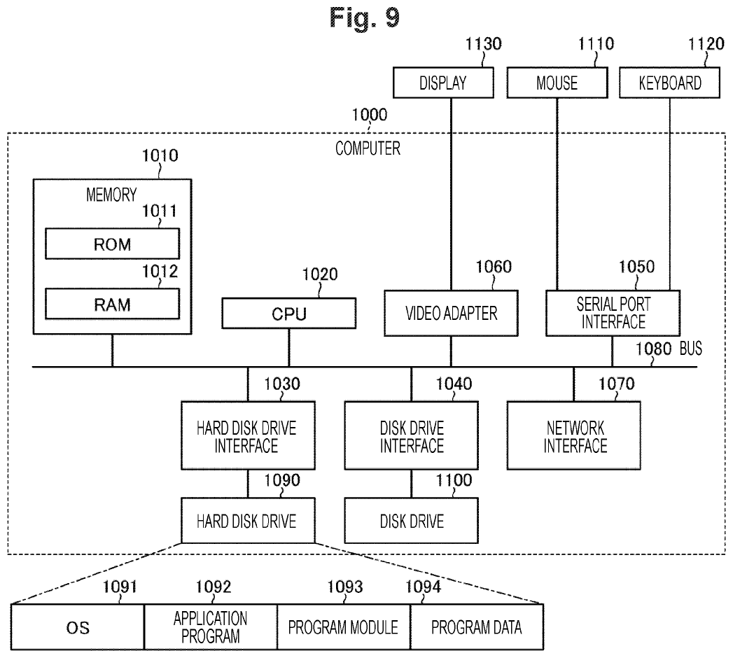

FIG. 9 is a diagram illustrating an example of a computer in which a program is executed to implement the signal processing device 10. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an operating system (OS) 1091, an application program 1092, a program module 1093, and program data 1094. That is, the program that defines the processing of the signal processing device 10 is implemented as the program module 1093 in which a code executable by the computer 1000 is described. The program module 1093 is stored in, for example, the hard disk drive 1090. For example, the program module 1093 for executing processing similar to the functional configurations in the signal processing device 10 is stored in the hard disk drive 1090. Note that the hard disk drive 1090 may be replaced with a solid state drive (SSD).

Furthermore, setting data used in the processing of the above-described embodiment is stored as the program data 1094, for example, in the memory 1010 or the hard disk drive 1090. The CPU 1020 then reads the program module 1093 and the program data 1094 stored in the memory 1010 or the hard disk drive 1090 into the RAM 1012 as necessary and executes the program module 1093 and the program data 1094.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may then be read by the CPU 1020 from the another computer via the network interface 1070.

While the embodiment to which the invention made by the present inventors is applied has been described above, the present invention is not limited by the description and drawings included as a part of the disclosure of the present invention according to the present embodiment. That is, other embodiments, examples, operation technologies, and the like made by those skilled in the art or the like on the basis of the present embodiment are all included in the scope of the present invention.

### REFERENCE SIGNS LIST

10 Signal processing device
11 Speech enhancement unit
12 Original sound addition unit
13 Speech recognition unit

1. A signal processing device comprising:
a speech enhancement unit that generates, from an observation signal, an enhancement signal in which a voice of a speaker is enhanced;
an addition unit that adds the observation signal to the enhancement signal; and
a speech recognition unit that performs speech recognition on the enhancement signal to which the observation signal is added by the addition unit.

2. The signal processing device according to claim 1, wherein the observation signal is an audio signal recorded by a single microphone.

3. The signal processing device according to claim 1, wherein the addition unit adjusts a weight of an observation signal to be added to the enhancement signal according to a ratio of a noise signal included in the observation signal.

4. The signal processing device according to claim 3, wherein the addition unit weights only an observation signal to be added to the enhancement signal, or weights both the observation signal and the observation signal to be added to the enhancement signal in a relationship in which a sum of a weight of the observation signal and a weight of the observation signal to be added to the enhancement signal is 1.

5. A signal processing method executed by a signal processing device, the signal processing method comprising:
a process of generating, from an observation signal, an enhancement signal in which a voice of a speaker is enhanced;
a process of adding the observation signal to the enhancement signal; and
a process of performing speech recognition on the enhancement signal to which the observation signal is added in the adding process.

6. A signal processing program for causing a computer to execute:
generating, from an observation signal, an enhancement signal in which a voice of a speaker is enhanced;
adding the observation signal to the enhancement signal; and
performing speech recognition on the enhancement signal to which the observation signal is added in the adding step.

7. The signal processing method according to claim 5, wherein the observation signal is an audio signal recorded by a single microphone.

8. The signal processing method according to claim 5, wherein a weight of an observation signal is adjusted to be added to the enhancement signal according to a ratio of a noise signal included in the observation signal.

9. The signal processing method according to claim 5, wherein an observation signal is weighted and added to the enhancement signal, or weights both the observation signal and the observation signal to be added to the enhancement signal in a relationship in which a sum of a weight of the observation signal and a weight of the observation signal to be added to the enhancement signal is 1.

10. The signal processing program according to claim 6, wherein the observation signal is an audio signal recorded by a single microphone.

11. The signal processing program according to claim 6, wherein a weight of an observation signal is adjusted to be added to the enhancement signal according to a ratio of a noise signal included in the observation signal.

12. The signal processing program according to claim 6, wherein an observation signal is weighted and added to the enhancement signal, or weights both the observation signal and the observation signal to be added to the enhancement signal in a relationship in which a sum of a weight of the observation signal and a weight of the observation signal to be added to the enhancement signal is 1.

13. The signal processing device according to claim 1, wherein the speech recognition unit performs speech recognition on modification emphasis signal and outputs a speech recognition result obtained by converting a message signal into text.

14. The signal processing device according to claim 1, wherein the speech recognition unit performs speech enhancement processing using a trained deep learning model.

15. The signal processing method according to claim 5, wherein speech recognition is performed on modification emphasis signal and a speech recognition result obtained by converting a message signal into text is output.

16. The signal processing method according to claim 5, wherein speech enhancement processing is performed using a trained deep learning model.

17. The signal processing program according to claim 6, wherein speech recognition is performed on modification emphasis signal and a speech recognition result obtained by converting a message signal into text is output.

18. The signal processing program according to claim 6, wherein speech enhancement is performed processing using a trained deep learning model.
